(19) United States
(12) Patent Application Publication
(10) Pub. No.: US 2025/0122009 A1
(43) Pub. Date: Apr. 17, 2025

(54) BIN LID LATCH

(71) Applicant: PAUL WILLIAM HORWOOD, TECOMA (AU)

(72) Inventor: PAUL WILLIAM HORWOOD, TECOMA (AU)

(21) Appl. No.: 18/907,462

(22) Filed: Oct. 4, 2024

(30) Foreign Application Priority Data
Oct. 13, 2023 (AU) 2023248206

(51) Int. Cl. B65F 1/16

(52) U.S. Cl. CPC B65F 1/1615; B65F 1/1646; B65F 2210/148

(57) ABSTRACT

A bin lid latch which is normally oriented in an upright orientation, includes a top part which extends substantially horizontally; a side part which is joined to the top part and which extends substantially vertically; and a bottom part which is joined to a bottom end of the side part and extends substantially horizontally to form a retaining surface and is configured to engage with an underside of a lip on a bin to restrain a bin lid from opening. A pivot point is located on the underside of the top part, configured to attach to the bin lid to form a pivot joint; and a stopper end of the top part extends for a short distance past the pivot point in a direction away from the side part. The stopper end limits rotation of the latch about the pivot point by abutting against the lid.

### CROSS-REFERENCE TO RELATED APPLICATION

None

### STATEMENT OF FEDERALLY SPONSORED RESEARCH OR DEVELOPMENT

None

### NAMES OF THE PARTIES TO A JOINT RESEARCH AGREEMENT

None

### REFERENCE TO A “SEQUENCE LISTING,” TABLE, OR COMPUTER PROGRAM LISTING

None

### FIELD OF THE INVENTION

This invention relates to a latch for a bin lid. It relates particularly but not exclusively to a bin lid latch which inhibits the opening of the lid when predated on by animals or when the bin falls over, but allows emptying of bin contents when the bin is fully inverted. The invention is particularly suitable for bins of the type commonly known as wheelie bins, but it can also be used on other types of bins.

### BACKGROUND TO THE INVENTION

In Australia, household waste is typically placed in wheelie bins. Typically these bins have a relatively square base and a height which is about 2½ times as large as the width and depth of the base. A lid is attached to the top of the bin by means of a hinge, and it normally sits across the top of the bin, closing the bin, held down by the force of gravity. Two wheels are attached to the base, making the bins easy to move.

Wheelie bins are commonly used in automated waste collection. When periodic waste collection is scheduled, a householder moves the bin into position near a kerb on a street outside the householder's house. A waste collection truck drives into position near a bin and, with various lifting mechanisms, seizes the bin, lifts it over a waste receptacle in the truck, and inverts the bin. Gravity causes the lid to swing open, causing the contents of the bin to be ejected into the truck's waste receptacle. The lifting mechanism then places the bin back on the ground right-way-up in its normal orientation.

Because wheelie bins are fairly high relative to the width and depth of their base, when filled they are susceptible to being blown over by strong weather winds or winds from fast moving vehicles moving past, especially when the bin is full if left standing on un-even or hilly ground, or is knocked over by pets, wild animals or by other causes. When a bin falls over, the lid typically opens fully or partially, and the contents of the bin are fully or partially disgorged onto the ground, leaving the householder with the unpleasant task of picking up the scattered waste and replace it back into the bin. On strong weather days the bin contents may be blown or washed away, resulting in waste pollution of the environment.

It is also not un-common for householder's pets or wild animals to predate on wheelie bins, seeking the waste inside. Some animals have learnt how to imitate the previously only human actions of opening the bin lid, resulting again in waste being disgorged onto the ground, resident clean up and potentially subsequent pollution of the environment.

To date, wheelie bin manufacturers have not remedied this problem en-masse, due primarily to the cost of current remedies versus the unpredictable nature of the events.

In order to try to remedy the problem, some residents have tried attaching a padlock or other fixing mechanism to the bin lid, keeping the bin lid permanently closed except when the padlock is removed. This prevents spillage if the bin falls over when the padlock is attached. However, bins are normally emptied when residents are not present, so the householders are required to leave their bins out ready for collection the night before. Bins are most vulnerable to being knocked or falling over during the night before collection because they are out on the street rather than in a sheltered position near the house. As the bin lid must be left unlocked to enable the waste collection truck to empty the bin, a bin with a padlock must be left un-locked, rendering it just as vulnerable as any other bin. The padlock method also presents the householders with the additional task to unlock and relock the bin every time they wish to deposit waste.

Some residents have installed commercially available, gravity-activated mechanisms on the bin lid. Such mechanisms are designed to inhibit the lid from opening and discharging the bin contents when the bin falls over, or when being predated upon by animals, while also allowing the lid to open when the bin is inverted by waste collection trucks when emptying bins. While such mechanisms typically involve considerable ingenuity, they also typically involve complicated internal mechanisms which are susceptible to failure except under exacting conditions, complicated to install, requiring multiple screws/bolts and or other fixings, maintenance, and failure due to oxidisation.

Such mechanisms, often fitted to the underside of the lid, or inside of the bin body, present a fouling point for waste, trapping waste on the mechanism itself during the emptying cycle.

Some mechanisms can also fail to unlatch when the wheelie bin is over-filled prior to the automated waste collection cycle.

Such mechanisms often are constructed from a variety of materials, whereas wheelie bins are commonly made from HDPE plastic, and are recycled intact at the end of their life span, when damaged or when standards change. Such mechanisms introduce other materials or forms of non-HDPE plastic, rubber and metals, contaminating the recycling process and rendering the bin itself incapable of being recycled without first engaging substantial labour to remove the mechanism. If left in place this also relegates the plastic from the bin to mixed-use plastic, robbing the industry of valuable pure HDPE plastic and increasing the volume of the lower value mixed-use plastic.

Some mechanisms use metal components, again contaminating the wheelie bin recycling process and rendering the bin itself incapable of being recycled without first engaging substantial labour to remove the mechanism.

Some mechanisms also require keys, levers or buttons to facilitate the manual opening of the bin lid, necessitating the resident to use two hands to open the bin, one to unlock the mechanism and one to lift the lid.

Some residents attach liquid filled plastic bottles or even bricks to the bin lid in order to make the lid too heavy for animals to lift. This approach resolves the problem of animals lifting the lid, but it does not stop animals pushing the bin over, or waste being disgorged when bins are blown over. Attached weights can also complicate the automated waste collection by rendering the bin too heavy.

As a result, there is currently no widely used commercially viable solution to the vulnerability of wheelie bins when tipped over, or predated upon by animals, which also allow the purposed operations and functions of the bin.

### SUMMARY OF THE INVENTION

According to this present invention, there is provided a bin lid latch which, when the bin lid latch is oriented in a normal orientation, includes:
(a) a top part which extends substantially horizontally;
(b) a side part which is joined to the top part and which extends substantially vertically;
(c) a bottom part which is joined to a bottom end of the side part and extends substantially horizontally to form a retaining surface and is configured to engage with an underside of a lip on a bin to restrain a bin lid from opening;
(d) a pivot point located on the underside of the top part, configured to attach to a bin lid to form a pivot joint; and
(e) a stopper end of the top part extending for a short distance past the pivot point in a direction away from the side part, wherein the stopper end limits rotation of the latch about the pivot point by abutting against the lid.

This present invention further provides a preferred bin lid latch arrangement for attachment to a hinged lid on a bin, the bin lid latch arrangement having:
(a) two bin lid latches, configured to be pivotally attached to a bin lid; and
(b) a handle, pivotally attached to two bin lid latches;
   wherein:
(c) when the bin is in a normal upright orientation, gravity causes each bin lid latch to orient itself such that its retaining surface is located directly under a protruding lip of the bin, preventing the lid from being opened without first rotating the bin lid latch about its pivot point; and
(d) when the bin is tipped or falls over, one or both of the retaining surfaces continue to be located directly under the bin's protruding lip, preventing the lid from being opened without first rotating both bin lid latches about their pivot points; and
(e) when the bin is inverted, gravity and the mass of the handle causes the bin lid latches to rotate about their pivot points, moving the retaining surfaces away from the bin's protruding lip and allowing the lid to open fully; and
(f) when the bin is returned to its normal upright orientation, gravity causes the bin lid latches to return to an orientation in which the retaining surfaces are located directly under the bin's protruding lip, preventing the lid from being opened without first rotating the bin lid latches about their pivot points.

Example embodiments of the invention will now be described in more detail by reference to the drawings. It is to be understood that the particularity of the drawings does not supersede the generality of the preceding description of the invention.

### BRIEF DESCRIPTION OF THE DRAWINGS

FIG. 1 is a perspective view of a bin lid latch according to a first embodiment of the present invention, showing two bin lid latches and a handle, installed on a bin lid.

FIG. 2 are perspective views of the bin lid latch shown in FIG. 1.

FIG. 3 is a perspective view of the handle shown in of FIG. 1.

FIGS. 4A to D are a series of cross-sectional views of the bin lid latch and handle of FIG. 1, shown installed on a bin, showing the bin lid latch and the bin lid in various orientations.

FIGS. 5A and B are further embodiments of the invention where a single bin lid latch, without handle, is installed on a bin lid.

### DETAILED DESCRIPTION

FIG. 1 shows a bin lid latch 1 according to an embodiment of the invention, as installed on a bin lid 2, which is attached by means of a hinge to bin 3 (only the top part of which is shown), which has a projecting lip 4. Bin lid latch 1 is shown in its normal upright orientation, which occurs when bin 3 is in its normal upright orientation. Whilst it will be appreciated that terms such as “top” and “bottom” could have different meanings in relation to an object as the orientation of the object is changed, such terms are used throughout this specification in reference to the location of features when items are in their normal upright orientation.

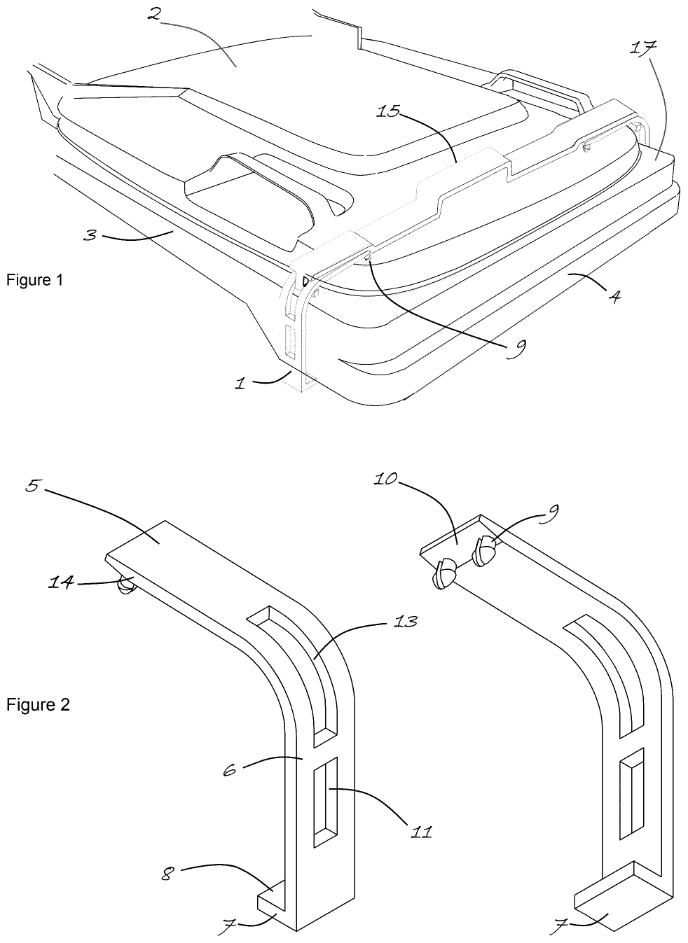

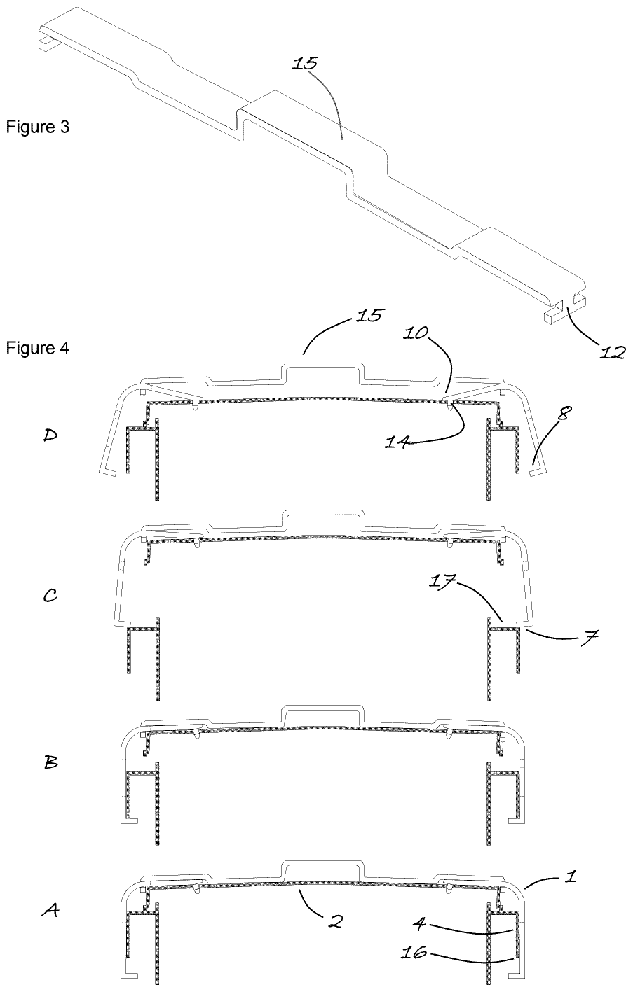

FIG. 2 shows bin lid latch 1 by itself. The bin lid latch in its normal upright orientation includes a top part 5 which extends substantially horizontally; a side part 6 which is joined to top part 5 and extends substantially vertically; and a bottom part 7 which is joined to a bottom end of side part 6 and extends substantially horizontally to form retaining surface 8 and is configured to engage with an underside 16 of the lip on the bin 4 to restrain a bin lid from opening.

Bin lid latch 1 also includes a pivot point 14 located on the underside of top part 5, configured to attach to the bin lid to form a pivot joint. In the particular embodiment illustrated, pivot point 14 comprises a pair of compression lugs 9 configured to fit into corresponding holes in the bin lid to form a hinged attachment to the bin lid. The holes may be drilled or punched into the bin lid, and the compression lugs can then be pushed into the holes. However, it will be appreciated that the pivot joint can be formed in many other ways including, for example, by having pivot point 14 comprised of a hinge pin configured to fit into corresponding hinge clips formed on the bin lid, or by having pivot point 14 comprised of one or more hinge clips configured to clip onto a corresponding hinge pin formed on the bin lid.

Bin lid latch 1 also includes a stopper end 10 of top part 5, extending for a short distance past the compression lugs 9 in a direction away from side part 6. Stopper end 10 limits rotation of the bin lid latch about the hinge formed by compression lugs 9 by abutting against the lid 2.

FIG. 2 shows a slot 11 in side part 6 of bin lid latch 1. This slot, which is not an essential part of the invention, can be used for padlock use in conjunction with a hole (not shown) drilled in the front lip 4 of a bin. This enables the bin to be padlocked if, for example, the owner wants to prevent the bin being opened whilst they are away for prolonged periods.

FIG. 2 also shows another optional slot 13 between parts 5 and 6 of bin lid latch 1. This slot can be used for pivotal connection to a handle 15 in the arrangement shown in FIGS. 1 and 4.

Operation of bin lid latch 1 is illustrated in FIGS. 4A to 4D. When bin 3 is in its normal upright orientation as shown in FIG. 4A, bin lid latch 1 overhangs the bin's protruding lip 4, and there is a small gap between retaining surface 8 and the underside 16 of lip 4.

When bin 3 falls over, or if it is slightly overfilled, lid 2 opens slightly as shown in FIG. 4B, causing retaining surface 8 to abut firmly against the underside 16 of lip 4, thereby preventing the lid from opening further and disgorging the contents of the bin. In order to ensure that the bin can be emptied even when it has been over-filled, it is preferred that retaining surface 8 is substantially perpendicular to protruding lip 4 when bin lid 2 is in its normally closed orientation, rather than being hooked upward.

When a person wishes to open bin lid 2 manually, the person simply lifts the bin lid latch handle 15, as shown in FIG. 4D. This moves the retaining surfaces 8 away from the underside 16 of bin lip 4, thus allowing the lid to open freely as shown in FIG. 4D.

When bin lid latch handle 15 is lifted as shown in FIG. 4D, stopper end 10 abutting against the top surface of lid 2 limits the extent to which bin lid latch 1 can rotate about pivot point 14. Predatory action by animals is impeded in that bin lid latch 1 needs to be lifted before bin lid 2 can be lifted up. Two separate, distinct and simultaneous actions are required to open the bin lid 2, and are normally only available to humans.

The ability for bin lid 2 to open when bin lid latch handle 15 is pulled up, is accomplished due to the rotation of bin lid latch 1 on its pivot points, and difference in the rotational arcs between bin lid 2 and its hinge, and bin lid latch 1 and its pivot point.

When lid 2 is being closed under the force of gravity as shown in FIG. 4C, bottom part 7 of bin lid latch 1 slides freely across the top surface 17 of protruding lip 4, allowing the bin lid and bin lid latch to fall back to the orientation shown in FIG. 4A, providing an automated re-latching operation.

The manner in which bin lid 2 opens when bin 3 is being emptied by a garbage truck is illustrated in FIGS. 4A to 4D. As bin 3 is tilted towards the truck, gravity operates on the handle 15 to rotate bin lid latch 1 away from protruding lip 4, as shown in FIGS. 4A and 4D. As the bin is inverted as shown in FIG. 4D, bin lid 2 is free to open. When the bin has been fully emptied, the truck restores the bin 3 to its normal upright position and lid 2 closes in the manner discussed above with reference to FIG. 4A.

In this preferred embodiment, two bin lid latches 1 are configured to be pivotally attached to bin lid 2. A handle 15 is pivotally attached to each of the two bin lid latches as in FIGS. 1 and 4. In the embodiments illustrated, the pivotal attachment occurs by means of keys 12 on the opposite ends of handle 15 being inserted through upper slots 13 in bin lid latches 1. It will be appreciated that this is only one way of creating a pivotal attachment, and many other ways are possible.

Handle 15 is pivotally connected to each bin lid latch 1 as follows: Bin lid latch 1 is rotated 90 degrees so that handle key 12 can be inserted into bin lid latch upper slot 13 from above. Bin lid latch 1 is then rotated 90 degrees back in the reverse direction, locking handle key 12 within bin lid latch 1.

When bin 3 is in its normal upright orientation, as shown in FIG. 1, gravity causes each bin lid latch 1 to orient itself such that its retaining surface 8 is located directly under the bin's protruding lip 4, preventing the lid 2 from being opened without first rotating bin lid latch 1 about its pivot point 14.

When bin 3 falls over, one or both of retaining surfaces 8 continue to be located directly under protruding lip 4, as shown in FIG. 4B, preventing lid 2 from being opened without first rotating bin lid latches 1 about the pivot points 14.

When a person pulls handle 15 upwards, the upward force on the handle creates an outward force on the two bin lid latches 1, and causes bin lid latches 1 to rotate about their pivot points 14, moving both retaining surfaces 8 away from the bin's protruding lip 4 as shown in FIG. 4D, and allowing the lid 2 to open fully.

Similarly, when bin 3 is inverted, gravity and the mass of handle 15 causes bin lid latches 1 to rotate about their pivot points 14, moving both retaining surfaces 8 away from the bin's protruding lip 4 as shown in FIG. 4D, and allowing the lid 2 to open fully.

When the bin is returned to its normal upright orientation, gravity causes bin lid 2 to start closing. This brings bottom parts 7 of bin lid latches 1 into contact with the top surfaces 17 of protruding lip 4, as shown in FIG. 4C. Bottom parts 7 slide freely across top surfaces 17 and then fall outside lip 4, allowing bin lid latches 1 to return to an orientation in which retaining surfaces 8 are located directly under protruding lip 4, preventing lid 2 from being opened without first rotating bin lid latches 1 about their pivot points 14.

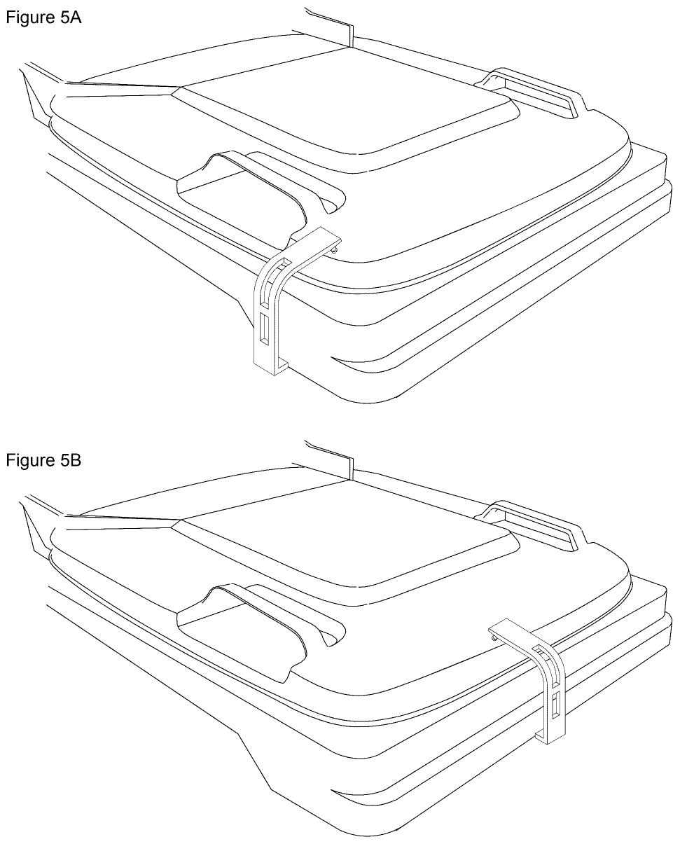

In other embodiments of the invention, there is a single bin lid latch 1 pivotally attached to the top of the bin lid 2 without handle 15. The single bin lid latch 1 can be pivotally attached on either side of the bin lid 2 as in FIG. 5A, or to the front centre of the bin lid furthest from the bin lid hinge and overhanging the front of the bin, as in FIG. 5B.

When a person wishes to open bin lid 2 manually, the person simply holds bin lid latch 1, using it as a handle and pulls it out as shown in FIG. 4D. This moves retaining surface 8 away from the underside 16 of lip 4, thus allowing the lid to open freely as shown in FIG. 4D. When bin lid latch 1 is pulled out as shown in FIG. 4D, stopper end 10 abutting against the top surface of lid 2 limits the extent to which bin lid latch 1 can rotate about pivot point 14. Predatory action by animals is impeded in that bin lid latch 1 needs to be pulled out before bin lid 2 can be lifted up. Two separate, distinct and simultaneous actions are required to open the bin lid 2, and are normally only available to humans.

The manner in which bin lid 2 opens when bin 3 is being emptied by a garbage truck is illustrated in FIGS. 4A to 4D. As bin 3 is tilted towards the truck, gravity operates to rotate bin lid latch 1 away from protruding lip 4, as shown in FIGS. 4A and 4D. As the bin is inverted as shown in FIG. 4D, bin lid 2 is free to open. When the bin has been fully emptied, the truck restores the bin 3 to its normal upright position and lid 2 closes in the manner discussed above with reference to FIG. 4A.

It is noted that while bin lid latch 1 as shown in FIG. 5B, will operate as described above, it is not suitable for use with garbage trucks that use a rear comb lifting mechanisms.

Bin lid latch arrangements according to each of the embodiments are especially preferred to be made from the same plastic as the bin to which the latch arrangement is to be attached. This ensures that the bin and bin lid can be recycled as one item without any labour to separate the invention from the bin lid, and prevents the contamination of the recycled plastics.

Bin lid latch 1 may be manufactured from any product suitable to its utilisation on any other form of bin.

The bin lid latch, manufactured from recycled HDPE, can be attached to a wheelie bin, which is then recycled whole or in part, thus returning the bin lid latch to the reservoir of recycled HDPE plastic in the circular recycling economy in the most cost effective way.

1. A bin lid latch which, when the bin lid latch is oriented in a normal upright orientation, includes:
(a) a top part which extends substantially horizontally;
(b) a side part which is joined to the top part and which extends substantially vertically;
(c) a bottom part which is joined to a bottom end of the side part and extends substantially horizontally to form a retaining surface and is configured to engage with an underside of a lip on a bin to restrain a bin lid from opening;
(d) a pivot point located on the underside of the top part, configured to attach to a bin lid to form a pivot joint; and
(e) a stopper end of the top part extending for a short distance past the pivot point in a direction away from the side part, wherein the stopper end limits rotation of the latch about the pivot point by abutting against the lid.

2. A bin lid latch according to claim 1 wherein the pivot point is formed by a pair of compression lugs which can be inserted into corresponding holes on the bin lid.

3. A bin lid latch according to claim 1 further including a hole which is configured to co-operate with a padlock, allowing the bin lid to be locked closed.

4. A bin lid latch arrangement for attachment to a hinged lid on a bin, the bin lid latch arrangement having:
(a) two bin lid latches according to claim 1 configured to be pivotally attached to a bin lid; and
(b) a handle pivotally attached to the two bin lid latches;
wherein:
(c) when the bin is in a normal upright orientation, gravity causes each bin lid latch to orient itself such that the retaining surface is located directly under a protruding lip of the bin, preventing the lid from being opened without first rotating the bin lid latch about its pivot point;
(d) when the bin falls over, one or both of the retaining surfaces continue to be located directly under the bin's protruding lip, preventing the lid from being opened without first rotating the bin lid latches about their pivot points;
(e) when the bin is inverted by mechanical means, gravity and the mass of the handle causes the bin lid latches to rotate about their pivot points, moving the retaining surfaces away from the bin's protruding lip and allowing the lid to open fully; and
(f) when the bin is returned to its normal upright orientation, gravity causes the bin lid latches to return to their normal orientation in which the retaining surfaces are located directly under the bin's protruding lip, preventing the lid from being opened without first rotating the bin lid latches about their pivot points.

5. A bin lid latch arrangement according to claim 4 wherein the bin lid latches are configured to overhang opposite sides at the front of the bin lid furthest from the bin lid hinge.
